(19) United States
(12) Patent Application Publication
(10) Pub. No.: US 2023/0224698 A1
(43) Pub. Date: Jul. 13, 2023

(54) METHODS, APPARATUS AND SYSTEMS FOR ADDRESS CONFIGURATION FOR INTEGRATED ACCESS AND BACKHAUL LINKS

(71) Applicant: ZTE Corporation, Shenzhen (CN)

(72) Inventors: Xueying DIAO, Shenzhen (CN); Lin CHEN, Shenzhen (CN); YING HUANG, Shenzhen (CN)

(73) Assignee: ZTE Corporation, Shenzhen (CN)

(21) Appl. No.: 17/960,559

(22) Filed: Apr. 5, 2023

Related U.S. Application Data
(63) Continuation of application No. PCT/CN2020/083898, filed on Apr. 9, 2020.

(51) Int. Cl. H04W 8/26; H04W 12/037

(52) U.S. Cl. CPC H04W 8/26; H04W 12/037

(57) ABSTRACT

Methods, apparatus and systems for address configuration for integrated access and backhaul (IAB) links are disclosed. In one embodiment, a method performed by a first network node is disclosed. The method comprises: obtaining, from an operations administration and maintenance (OAM) or a second network node, a first address information related to at least one Internet Protocol security (IPsec) address; generating, based on the first address information, a second address information; and transmitting, to the second network node, the second address information based on a radio resource control (RRC) message, wherein the first network node and the second network node are connected via a backhaul link in an integrated access and backhaul (IAB) network.

### TECHNICAL HELD

The disclosure relates generally to wireless communications and, more particularly, to methods, apparatus and systems for address configuration for wireless communications based on integrated access and backhaul (IAB) links.

### BACKGROUND

Compared to a long term evolution (LTE) system, a fifth generation (5G) new radio (NR) system has a larger available bandwidth, as well as a massive MIMO and a multi-beam, which enables research and application of Integrated Access and Backhaul (IAB) links. Through wireless backhaul links and relay links, dense NR cell networks can be deployed more flexibly without the need to increase the dense deployment of transmission networks and without the need of laying a large number of optical fibers, which saves network deployment costs.

After accessing a node in an IAB network, a user equipment (UE) may transmit data through a multi-hop relay backhaul link between the access node and the core network. Since it is an important technical feature in NR to split a base station functionality into two functional units: a central unit (CU) and a distributed unit (DU), the IAB function may be supported in a CU-DU separation deployment scenario. But there is no existing complete solution for transport layer address configuration in IAB networks. In other words, existing systems and methods related to transport layer address configuration for wireless communications based on IAB links are not entirely satisfactory.

### SUMMARY OF THE INVENTION

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In one embodiment, a method performed by a first network node is disclosed. The method comprises: obtaining, from an operations administration and maintenance (OAM) or a second network node, a first address information related to at least one Internet Protocol security (IPsec) address: generating, based on the first address information, a second address information; and transmitting, to the second network node, the second address information based on a radio resource control (RRC) message, wherein the first network node and the second network node are connected via a backhaul link in an integrated access and backhaul (IAB) network.

In another embodiment, a method performed by a first network node is disclosed. The method comprises: transmitting, to a second network node, an address request information based on an F1 application protocol (F1AP) message; and obtaining, from the second network node, a first address information related to at least one IP address or at least one IPsec address of a third network node in response to the address request information. The first network node and the second network node are connected via an F1 interface in an integrated access and backhaul (IAB) network. The first network node and the third network node are connected via a backhaul link in the IAB network.

In yet another embodiment, a method performed by a first network node is disclosed. The method comprises: transmitting, to a second network node, a first address information related to at least one Internet Protocol security (IPsec) address; and obtaining, from the second network node based on a radio resource control (RRC) message, a second address information generated based on the first address information, wherein the first network node and the second network node are connected via a backhaul link in an integrated access and backhaul (IAB) network.

In still another embodiment, a method performed by a first network node is disclosed. The method comprises: obtaining, from a second network node, an address request information based on an F1 application protocol (F1AP) message; and transmitting, to the second network node, a first address information related to at least one IP address or at least one IPsec address of a third network node in response to the address request information. The first network node and the second network node are connected via an F1 interface in an integrated access and backhaul (IAB) network. The second network node and the third network node are connected via a backhaul link in the IAB network.

In a different embodiment, a network node configured to carry out a disclosed method in some embodiment is disclosed. In yet another embodiment, a non-transitory computer-readable medium having stored thereon computer-executable instructions for carrying out a disclosed method in some embodiment is disclosed.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader’s understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1 illustrates an exemplary Integrated Access and Backhaul (IAB) network in which techniques disclosed herein may be implemented, in accordance with some embodiments of the present disclosure.

FIG. 2 illustrates exemplary IAB links in an IAB network through which techniques disclosed herein may be implemented, in accordance with some embodiments of the present disclosure.

FIG. 3 illustrates a block diagram of an IAB node, in accordance with some embodiments of the present disclosure.

FIG. 4 illustrates a flow chart for a method performed by an IAB node for address configuration, in accordance with some embodiments of the present disclosure.

FIG. 5 illustrates a block diagram of an IAB donor, in accordance with some embodiments of the present disclosure.

FIG. 6 illustrates a flow chart for a method performed by an IAB donor for address configuration, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

A typical wireless communication network includes one or more base stations (typically known as a “BS”) that each provides geographical radio coverage, and one or more wireless user equipment devices (typically known as a “UE”) that can transmit and receive data within the radio coverage. In the wireless communication network, a BS and a UE can communicate with each other via a communication link, e.g., via a downlink radio frame from the BS to the UE or via an uplink radio frame from the UE to the BS. In a multi-hop relay system, one or more relay nodes may be deployed between a BS and a UE on each branch of the multi-hop relay system.

In various embodiments, a BS is referred to as a network side node and can include, or be implemented as, a next Generation Node B (gNB), an E-UTRAN Node B (eNB), a Transmission/Reception Point (TRP), an Access Point (AP), a donor node (DN), etc. A UE in the present disclosure can be referred to as a terminal and can include, or be implemented as, a mobile station (MS), a station (STA), etc. An IAB node and an IAB donor may be described herein as non-limiting examples of “wireless communication nodes” or “network nodes”; and a UE may be described herein as non-limiting examples of “wireless communication devices.” The BS, IAB node, IAB donor, and UE can practice the methods disclosed herein and may be capable of wireless and/or wired communications, in accordance with various embodiments of the present disclosure.

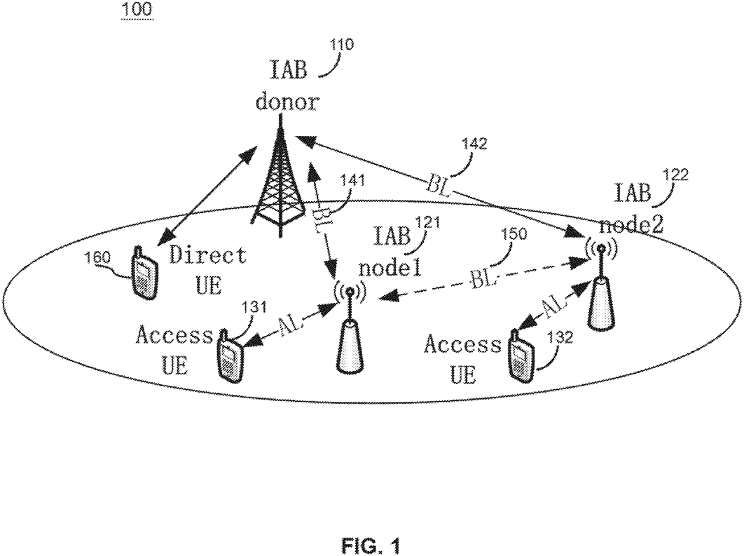

FIG. 1 illustrates an exemplary Integrated Access and Backhaul (IAB) network 100 in which techniques disclosed herein may be implemented, in accordance with an embodiment of the present disclosure. As shown in FIG. 1, the exemplary IAB network 100 includes a base station, the IAB donor 110, a plurality of IAB relay nodes, 121, 122, and a plurality of UEs 160, 131, 132. The IAB donor 110 is connected to the core network to provide a wireless backhaul function for the IAB nodes 121, 122, and provides a radio access function for the UEs. The UE 160 under the IAB donor 110 is called a direct UE. An IAB node has two functions: an access node function and a UE function. The access node function means the IAB node can work like a base station to provide the radio access function for a UE. The UE function means the IAB node can work like a UE to be controlled and scheduled by the IAB donor or an upper IAB node. A UE, e.g. the UEs 131, 132, under an IAB node is called an access UE.

A link between an IAB donor and an IAB node, as well as a link between the IAB nodes, is called a backhaul link (BL). A link between an IAB node and a UE is called an access link (AL). As shown in FIG. 1, while the BL 141 and the BL 142 have been established, the IAB node 1 121 and the IAB node 2 122 may want to establish the BL 150 between them, to avoid a failure of handover or radio link or to improve communication quality.

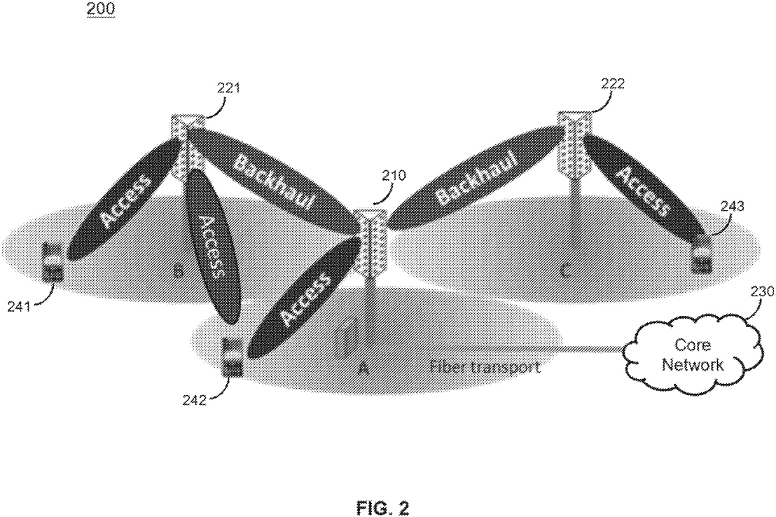

FIG. 2 illustrates exemplary IAB links in an IAB network 200 through which techniques disclosed herein may be implemented, in accordance with some embodiments of the present disclosure. As shown in FIG. 2, the IAB network 200 comprises three access nodes: node A 210, node B 221, and node C 222. A UE can access one of the three access nodes through an access link. While there is a wired connection, e.g. via fiber transport, between access node A 210 and the core network 230, there is no wired connection between any of access nodes B 221 and C 222, and the core network 230. An access node that supports a wireless access of the UE and wirelessly transmits data back to core network in the IAB network is called an IAB node, e.g. node B 221 or node C 222 in FIG. 2. An access node that provides a wireless backhaul function for an IAB node so that the UE connects to the core network in the IAB network is called an IAB donor, e.g. node A 210 in FIG. 2. The access nodes can transmit data to each other through a wireless backhaul link. For example, the IAB node B 221 can transmit data received from UE 241 to the IAB donor A 210, via a wireless backhaul link. Then the IAB donor A 210 may send the UE data to a network element of the core network 230. For the downlink, a network element of the core network 230 may send a data packet for UE to the IAB donor A 210. Then the IAB donor A 210 can transmit the data to the IAB node B 221 through the wireless backhaul link. The IAB node B 221 may then transmit the data to the UE 241 via the access link. According to various embodiments, the access link and the backhaul link can use the same carrier frequency or different carrier frequencies.

To have a secure connection between an IAB donor and an IAB node, an IP packet transmitted between the IAB donor and the IAB node may be encrypted based on an IPsec protocol. As such, it is desirable for the IAB donor and the IAB node to know each other’s IP address and IPsec address for a secure communication.

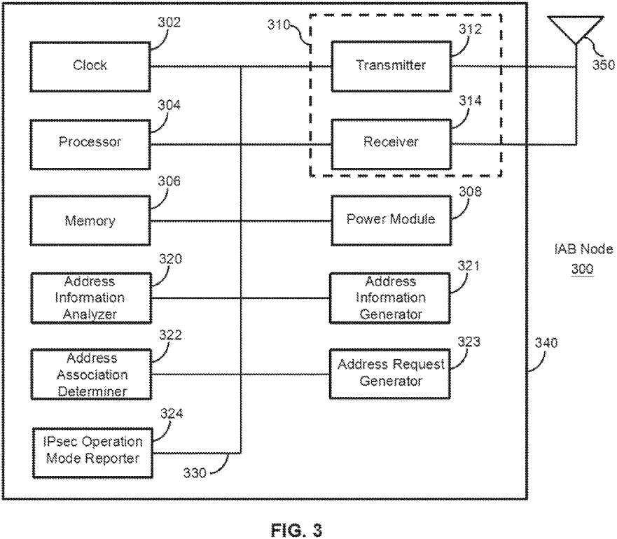

FIG. 3 illustrates a block diagram of an IAB node 300, in accordance with some embodiments of the present disclosure. The IAB node 300 is an example of a node that can be configured to implement the various methods described herein. As shown in FIG. 3, the IAB node 300 includes a housing 340 containing a system clock 302, a processor 304, a memory 306, a transceiver 310 comprising a transmitter 312 and receiver 314, a power module 308, an address information analyzer 320, an address information generator 321, an address association determiner 322, an address request generator 323, and an IPsec operation mode reporter 324.

In this embodiment, the system clock 302 provides the timing signals to the processor 304 for controlling the timing of all operations of the IAB node 300. The processor 304 controls the general operation of the IAB node 300 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 306, which can include both read-only memory (ROM) and random access memory (RAM), can provide instructions and data to the processor 304. A portion of the memory 306 can also include non-volatile random access memory (NVRAM). The processor 304 typically performs logical and arithmetic operations based on program instructions stored within the memory 306. The instructions (a.k.a., software) stored in the memory 306 can be executed by the processor 304 to perform the methods described herein. The processor 304 and memory 306 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 310, which includes the transmitter 312 and receiver 314, allows the IAB node 300 to transmit and receive data to and from a remote device (e.g., a BS, a RN, or a UE). An antenna 350 is typically attached to the housing 340 and electrically coupled to the transceiver 310. In various embodiments, the IAB node 300 includes (not shown) multiple transmitters, multiple receivers, and multiple transceivers. In one embodiment, the antenna 350 is replaced with a multi-antenna array 350 that can form a plurality of beams each of which points in a distinct direction. The transmitter 312 can be configured to wirelessly transmit packets having different packet types or functions, such packets being generated by the processor 304. Similarly, the receiver 314 is configured to receive packets having different packet types or functions, and the processor 304 is configured to process packets of a plurality of different packet types. For example, the processor 304 can be configured to determine the type of packet and to process the packet and/or fields of the packet accordingly.

In an IAB network, the IAB node 300 may be connected to an IAB donor via a backhaul link. In one embodiment, the IAB node 300 exchanges signaling with the IAB donor to determine the IPsec address and the IP address of the IAB node 300. For example, the address information analyzer 320 may obtain, from an operations administration and maintenance (OAM), and analyze a first address information related to at least one IP address and at least one IPsec address of the IAB node 300. The address information generator 321 may generate, based on the first address information, a second address information related to the at least one IP address and the at least one IPsec address; and transmit, via the transmitter 312 to a CU of the IAB donor, the second address information.

In one embodiment, the first address information comprises information related to at least one of the following: at least one IPsec address of the IAB node 300: at least one IP address of the IAB node 300; at least one IPsec address used for a control plane; at least one IPsec address used for a user plane; at least one IPsec address used for the control plane, and at least one IP address used for the control plane and associated with each IPsec address used for the control plane; or at least one IPsec address used for the user plane, and at least one IP address used for the user plane and associated with each IPsec address used for the user plane.

In another embodiment, the first address information comprises information related to at least one of the following: at least one IPsec address of the IAB node 300, or at least one IP address of the IAB node 300. The address association determiner 322 may determine, based on the first address information, at least one of the following: at least one IPsec address used for a control plane; at least one IPsec address used for a user plane; at least one IPsec address used for the control plane, and at least one IP address used for the control plane and associated with each IPsec address used for the control plane; or at least one IPsec address used for the user plane, and at least one IP address used for the user plane and associated with each IPsec address used for the user plane.

In one embodiment, the second address information comprises information related to at least one of the following: at least one IPsec address of the IAB node 300; at least one IP address of the IAB node 300; at least one IPsec address used for a control plane; or at least one IPsec address used for the control plane, and at least one IP address used for the control plane and associated with each IPsec address used for the control plane. The second address information may be transmitted based on a radio resource control (RRC) message or an F1 application protocol (F1AP) message.

In one embodiment, the address information analyzer 320 may obtain, from the OAM, and analyze a first address information related to at least one IPsec address of the IAB node 300. The address information generator 321 may generate, based on the first address information, a second address information; and transmit, via the transmitter 312 to a CU of the IAB donor, the second address information. The address information analyzer 320 may then obtain, from the IAB donor CU, a third address information related to at least one IP address of the IAB node 300.

In one embodiment, the second address information is transmitted based on a RRC message and comprises information related to at least one of the following: at least one IPsec address of the IAB node 300; at least one IPsec address used for a control plane; at least one IPsec address used for a user plane; or a quantity of at least one IP address associated with each IPsec address used for the control plane or the user plane.

The IAB donor CU may obtain, by the IAB donor CU itself or from a distributed unit (DU) of the IAB donor, an IP address information of the IAB node 300. The third address information may be generated based on the IP address information and obtained based on a RRC message. In one embodiment, the third address information comprises information related to at least one of the following: at least one IP address of the IAB node 300, at least one IP address used for the control plane, at least one IP address used for the user plane. In one embodiment, the third address information also comprises at least one IP address associated with each IPsec address used for the control plane or the user plane. In another embodiment, the address information generator 321 generates and transmits, via the transmitter 312 to the IAB donor CU, a fourth address information related to at least one IP address associated with each IPsec address used for the control plane or the user plane.

In one embodiment, the second address information is transmitted based on a RRC message and comprises information related to at least one of the following: at least one IPsec address of the IAB node 300, or a quantity of at least one IP address associated with each IPsec address. In one embodiment, the IAB donor CU obtains, by the CU itself or from the IAB donor DU, an IP address information of the IAB node 300. The third address information comprises information related to at least one of the following: at least one IPsec address of the IAB node 300 used for a control plane; at least one IPsec address of the IAB node 300 used for a user plane; at least one IP address of the IAB node 300: at least one IP address used for the control plane; at least one IP address used for the user plane: or at least one IP address associated with each IPsec address used for the control plane or the user plane. The at least one IP address associated with each IPsec address used for the control plane or the user plane may be determined by at least one of the following: the IAB donor CU, the IAB donor DU or the IAB node 300.

In one embodiment, the address request generator 323 may generate and transmit, via the transmitter 312 to the IAB donor CU, an address request information. The address information analyzer 320 then obtains, from the IAB donor CU, a first address information related to at least one IP address and at least one IPsec address of the IAB node 300. Each of the at least one IP address and the at least one IPsec address is assigned by the IAB donor CU or the IAB donor DU.

The address request information may be transmitted based on a radio resource control (RRC) message and comprise information related to at least one of the following: a request for at least one IPsec address, a request for a number of at least one IPsec address, a request for at least one IPsec address used for a control plane, a request for at least one IPsec address used for a user plane, a request for a number of at least one IPsec address used for a control plane, a request for a number of at least one IPsec address used for a user plane, a request for an IPsec address version, an indication of a number of at least one IP address associated with each IPsec address, an indication of a number of at least one control plane IP address associated with each control plane IPsec address, or an indication of a number of at least one user plane IP address associated with each user plane IPsec address.

In one embodiment, both the at least one IP address and the at least one IPsec address are assigned by the IAB donor CU. The first address information is obtained based on a RRC message and comprises information related to at least one of the following: the at least one IPsec address, the at least one IP address, at least one IPsec address used for a control plane, at least one IP address used for the control plane, at least one IPsec address used for a user plane, at least one IP address used for the user plane, at least one control plane IP address associated with each control plane IPsec address, or at least one user plane IP address associated with each user plane IPsec address.

The address information generator 321 may generate a second address information based on the first address information; and transmit, via the transmitter 312 to the IAB donor CU, the second address information based on a RRC message or an F1AP message. The second address information comprises information related to at least one of the following: at least one IPsec address used for a control plane, at least one IP address used for the control plane, at least one IPsec address used for a user plane, at least one IP address used for the user plane, at least one control plane IP address associated with each control plane IPsec address, or at least one user plane IP address associated with each user plane IPsec address.

In one embodiment, the IAB donor CU may forward the address request information to the IAB donor DU via an F1 interface. The address request information comprises information related to at least one of the following: a request for at least one IPsec address, a request for at least one IP address, a request for a number of at least one IPsec address, a request for at least one IPsec address used for a control plane, a request for at least one IP address used for the control plane, a request for at least one IPsec address used for a user plane, a request for at least one IP address used for the user plane, a request for a number of at least one IPsec address used for a control plane, a request for a number of at least one IPsec address used for a user plane, a request for an IPsec address version, an indication of a number of at least one IP address associated with each IPsec address, an indication of a number of at least one control plane IP address associated with each control plane IPsec address, or an indication of a number of at least one user plane IP address associated with each user plane IPsec address.

In one embodiment, the at least one IPsec address is assigned by the IAB donor CU: and the at least one IP address is assigned by the IAB donor DU. The IAB donor CU obtains the at least one IP address from the IAB donor DU, and generates the first address information based on the at least one IP address. In another embodiment, the at least one IP address is assigned by the IAB donor CU; and the at least one IPsec address is assigned by the IAB donor DU. The IAB donor CU obtains the at least one IPsec address from the IAB donor DU, and generates the first address information based on the at least one IPsec address. In yet another embodiment, both the at least one IP address and the at least one IPsec address are assigned by the IAB donor DU. The IAB donor CU obtains the at least one IP address and the at least one IPsec address from the IAB donor DU, and generates the first address information based on the at least one IP address and the at least one IPsec address. In each of the three embodiments, the first address information is obtained based on a radio resource control RRC message and comprises information related to at least one of the following: the at least one IPsec address, the at least one IP address, at least one IPsec address used for a control plane, at least one IP address used for the control plane, at least one IPsec address used for a user plane, at least one IP address used for the user plane, at least one IP address associated with each control plane IPsec address, or at least one IP address associated with each user plane IPsec address. The at least one IP address associated with each control plane IPsec address or each user plane IPsec address may be determined by at least one of the following: the IAB donor CU, the IAB donor DU or the IAB node 300.

In one embodiment, the address information analyzer 320 may obtain, via the receiver 314 from the OAM or the IAB donor CU, and analyze an address information related to at least one IPsec address of the IAB donor CU. The address information comprises information related to at least one of the following: at least one IPsec address of the IAB donor CU, at least one control plane IPsec address of the IAB donor CU, or at least one control plane IP address associated with each control plane IPsec address of the IAB donor CU.

In one embodiment, the IPsec operation mode reporter 324 may generate and transmit, via the transmitter 312 to the IAB donor CU, an indication indicating each IPsec operation mode supported by the IAB node 300. The supported IPsec operation mode may be: a tunnel mode, a transport mode, or both the tunnel mode and the transport mode.

The power module 308 can include a power source such as one or more batteries, and a power regulator, to provide regulated power to each of the above-described modules in FIG. 3. In some embodiments, if the IAB node 300 is coupled to a dedicated external power source (e.g., a wall electrical outlet), the power module 308 can include a transformer and a power regulator.

The various modules discussed above are coupled together by a bus system 330. The bus system 330 can include a data bus and, for example, a power bus, a control signal bus, and/or a status signal bus in addition to the data bus. It is understood that the modules of the IAB node 300 can be operatively coupled to one another using any suitable techniques and mediums.

Although a number of separate modules or components are illustrated in FIG. 3, persons of ordinary skill in the art will understand that one or more of the modules can be combined or commonly implemented. For example, the processor 304 can implement not only the functionality described above with respect to the processor 304, but also implement the functionality described above with respect to the address information analyzer 320. Conversely, each of the modules illustrated in FIG. 3 can be implemented using a plurality of separate components or elements.

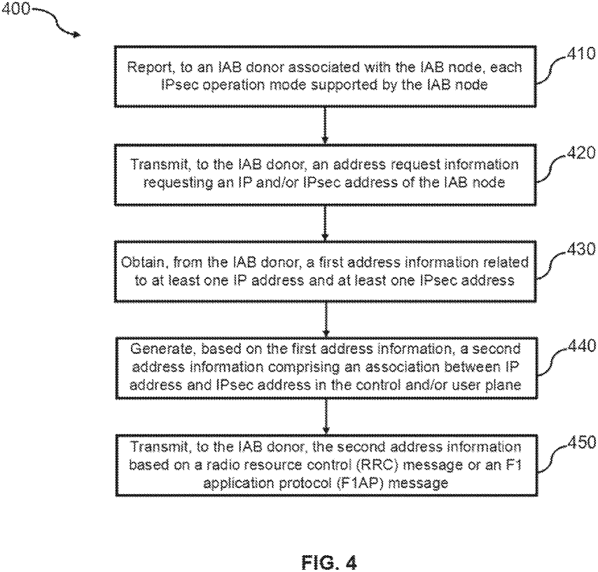

FIG. 4 illustrates a flow chart for a method 400 performed by an IAB node, e.g. the IAB node 300 in FIG. 3, for address configuration, in accordance with some embodiments of the present disclosure. At operation 410, the IAB node reports, to an IAB donor associated with the IAB node, each IPsec operation mode supported by the IAB node. At operation 420, the IAB node transmits, to the IAB donor, an address request information requesting an IP and/or IPsec address of the IAB node. At operation 430, the IAB node obtains, from the IAB donor, a first address information related to at least one IP address and at least one IPsec address of the IAB node. At operation 440, the IAB node generates, based on the first address information, a second address information comprising an association between IP address and IPsec address in the control and/or user plane. At operation 450, the IAB node transmits, to the IAB donor, the second address information based on a radio resource control (RRC) message or an F1 application protocol (F1AP) message. The orders of operations in FIG. 4 may be changed in various embodiments of the present disclosure.

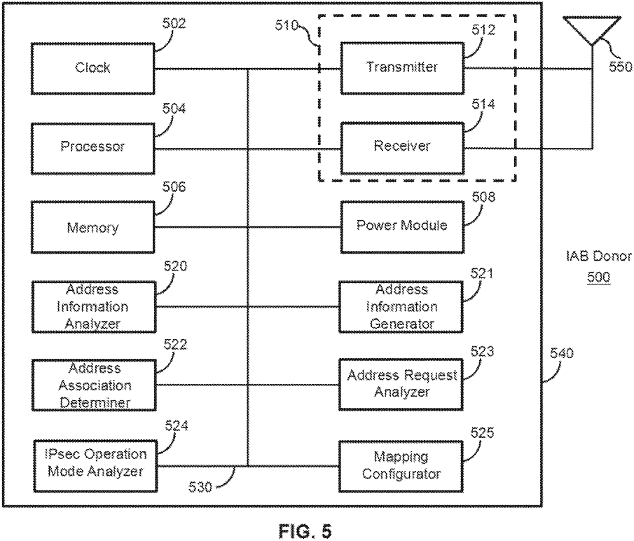

FIG. 5 illustrates a block diagram of an IAB donor 500 in accordance with some embodiments of the present disclosure. The IAB donor 500 is an example of a node that can be configured to implement the various methods described herein. As shown in FIG. 5, the IAB donor 500 includes a housing 540 containing a system clock 502, a processor 504, a memory 506, a transceiver 510 comprising a transmitter 512 and a receiver 514, a power module 508, an address information analyzer 520, an address information generator 521, an address association determiner 522, an address request analyzer 523, an IPsec operation mode analyzer 524. and a mapping configurator 525.

In this embodiment, the system clock 502, the processor 504, the memory 506, the transceiver 510 and the power module 508 work similarly to the system clock 302, the processor 304, the memory 306, the transceiver 310 and the power module 308 in the IAB node 300. An antenna 550 or a multi-antenna array 550 is typically attached to the housing 440 and electrically coupled to the transceiver 510.

In one embodiment, the node 500 in FIG. 5 represents a CU of an IAB donor, while a DU of the IAB donor may have a similar structure to the node 500 in FIG. 5. In an IAB network, the IAB donor CU 500 may be connected to an IAB node via a backhaul link. In one embodiment, the IAB donor CU 500 exchanges signaling with the IAB node to determine the IPsec address and the IP address of the IAB node. For example, the address information analyzer 520 may obtain, via the receiver 514 from the IAB node, and analyze a first address information related to at least one IP address and at least one IPsec address of the IAB node. The first address information is generated based on a second address information from an operations administration and maintenance (OAM).

In one embodiment, the second address information comprises information related to at least one of the following: at least one IPsec address of the IAB node; at least one IP address of the IAB node; at least one IPsec address used for a control plane; at least one IPsec address used for a user plane; at least one IPsec address used for the control plane, and at least one IP address used for the control plane and associated with each IPsec address used for the control plane: or at least one IPsec address used for the user plane, and at least one IP address used for the user plane and associated with each IPsec address used for the user plane.

In another embodiment, the second address information comprises information related to at least one of the following: at least one IPsec address of the IAB node, or at least one IP address of the IAB node. The IAB node can determine, based on the second address information, at least one of the following: at least one IPsec address used for a control plane; at least one IPsec address used for a user plane; at least one IPsec address used for the control plane, and at least one IP address used for the control plane and associated with each IPsec address used for the control plane; or at least one IPsec address used for the user plane, and at least one IP address used for the user plane and associated with each IPsec address used for the user plane.

In one embodiment, the first address information comprises information related to at least one of the following: at least one IPsec address of the IAB node; at least one IP address of the IAB node; at least one IPsec address used for a control plane; or at least one IPsec address used for the control plane, and at least one IP address used for the control plane and associated with each IPsec address used for the control plane. The first address information may be transmitted based on a radio resource control (RRC) message or an F1 application protocol (F1AP) message.

In one embodiment, the address information analyzer 520 may obtain, via the receiver 514 from the IAB node, and analyze a first address information related to at least one IPsec address of the IAB node. The first address information is generated based on a second address information from the OAM. The address information generator 521 may generate, in response to the first address information, a third address information related to at least one IP address of the IAB node: and transmit, via the transmitter 512 to the IAB node, the third address information.

In one embodiment, the first address information is obtained based on a RRC message and comprises information related to at least one of the following: at least one IPsec address of the IAB node; at least one IPsec address used for a control plane; at least one IPsec address used for a user plane; or a quantity of at least one IP address associated with each IPsec address used for the control plane or the user plane.

In one embodiment, the address information analyzer 520 may obtain, by the IAB donor CU 500 itself or from a DU of the IAB donor, an IP address information of the IAB node. The third address information may be generated based on the IP address information and transmitted based on a RRC message. In one embodiment, the third address information comprises information related to at least one of the following: at least one IP address of the IAB node, at least one IP address used for the control plane, at least one IP address used for the user plane. In one embodiment, the third address information also comprises at least one IP address associated with each IPsec address used for the control plane or the user plane determined by the address association determiner 522. In another embodiment, the address information analyzer 520 may obtain, via the receiver 514 from the IAB node, a fourth address information related to at least one IP address associated with each IPsec address used for the control plane or the user plane.

In one embodiment, the first address information is obtained based on a RRC message and comprises information related to at least one of the following: at least one IPsec address of the IAB node, or a quantity of at least one IP address associated with each IPsec address. In one embodiment, the address information analyzer 520 obtains, by the IAB donor CU 500 itself or from the IAB donor DU, an IP address information of the IAB node. The third address information is generated based on the IP address information and comprises information related to at least one of the following: at least one IPsec address of the IAB node used for a control plane; at least one IPsec address of the IAB node used for a user plane; at least one IP address of the IAB node; at least one IP address used for the control plane; at least one IP address used for the user plane: or at least one IP address associated with each IPsec address used for the control plane or the user plane. The at least one IP address associated with each IPsec address used for the control plane or the user plane may be determined by at least one of the following: the IAB donor CU 500, the IAB donor DU or the IAB node.

In one embodiment, the address request analyzer 523 may obtain, via the receiver 514 from the IAB node, and analyze an address request information. The address information generator 521 may transmit, via the transmitter 512 to the IAB node, a first address information related to at least one IP address and at least one IPsec address of the IAB node. Each of the at least one IP address and the at least one IPsec address is assigned by the IAB donor CU 500 or the IAB donor DU, based on the address request information.

The address request information may be transmitted based on a RRC message and comprise information related to at least one of the following: a request for at least one IPsec address, a request for a number of at least one IPsec address, a request for at least one IPsec address used for a control plane, a request for at least one IPsec address used for a user plane, a request for a number of at least one IPsec address used for a control plane, a request for a number of at least one IPsec address used for a user plane, a request for an IPsec address version, an indication of a number of at least one IP address associated with each IPsec address, an indication of a number of at least one control plane IP address associated with each control plane IPsec address, or an indication of a number of at least one user plane IP address associated with each user plane IPsec address.

In one embodiment, both the at least one IP address and the at least one IPsec address are assigned by the IAB donor CU 500. The first address information is obtained based on a RRC message and comprises information related to at least one of the following: the at least one IPsec address, the at least one IP address, at least one IPsec address used for a control plane, at least one IP address used for the control plane, at least one IPsec address used for a user plane, at least one IP address used for the user plane, at least one control plane IP address associated with each control plane IPsec address, or at least one user plane IP address associated with each user plane IPsec address.

The address information analyzer 520 may obtain, via the receiver 514 from the IAB node, a second address information based on a RRC message or an F1AP message. The second address information is generated based on the first address information and comprises information related to at least one of the following: at least one IPsec address used for a control plane, at least one IP address used for the control plane, at least one IPsec address used for a user plane, at least one IP address used for the user plane, at least one control plane IP address associated with each control plane IPsec address, or at least one user plane IP address associated with each user plane IPsec address.

In one embodiment, the address request analyzer 523 may forward the address request information to the IAB donor DU via an F1 interface. The address request information comprises information related to at least one of the following: a request for at least one IPsec address, a request for at least one IP address, a request for a number of at least one IPsec address, a request for at least one IPsec address used for a control plane, a request for at least one IP address used for the control plane, a request for at least one IPsec address used for a user plane, a request for at least one IP address used for the user plane, a request for a number of at least one IPsec address used for a control plane, a request for a number of at least one IPsec address used for a user plane, a request for an IPsec address version, an indication of a number of at least one IP address associated with each IPsec address, an indication of a number of at least one control plane IP address associated with each control plane IPsec address, or an indication of a number of at least one user plane IP address associated with each user plane IPsec address.

In one embodiment, the at least one IPsec address is assigned by the IAB donor CU 500; and the at least one IP address is assigned by the IAB donor DU. The address information analyzer 520 obtains the at least one IP address from the IAB donor DU, and the address information generator 521 generates the first address information based on the at least one IP address. In another embodiment, the at least one IP address is assigned by the IAB donor CU 500; and the at least one IPsec address is assigned by the IAB donor DU. The address information analyzer 520 obtains the at least one IPsec address from the IAB donor DU, and the address information generator 521 generates the first address information based on the at least one IPsec address. In yet another embodiment, both the at least one IP address and the at least one IPsec address are assigned by the IAB donor DU. The address information analyzer 520 obtains the at least one IP address and the at least one IPsec address from the IAB donor DU, and the address information generator 521 generates the first address information based on the at least one IP address and the at least one IPsec address. In each of the three embodiments, the first address information is obtained based on a radio resource control RRC message and comprises information related to at least one of the following: the at least one IPsec address, the at least one IP address, at least one IPsec address used for a control plane, at least one IP address used for the control plane, at least one IPsec address used for a user plane, at least one IP address used for the user plane, at least one IP address associated with each control plane IPsec address, or at least one IP address associated with each user plane IPsec address. The at least one IP address associated with each control plane IPsec address or each user plane IPsec address may be determined by at least one of the following: the IAB donor CU 500, the IAB donor DU or the IAB node.

In one embodiment, the address information generator 521 may generate and transmit, via the transmitter 512 to the IAB node, an address information related to at least one IPsec address of the IAB donor CU 500. The address information comprises information related to at least one of the following: at least one IPsec address of the IAB donor CU 500, at least one control plane IPsec address of the IAB donor CU 500, or at least one control plane IP address associated with each control plane IPsec address of the IAB donor CU 500.

In one embodiment, the IPsec operation mode analyzer 524 may obtain, via the receiver 514 from the IAB node, and analyze an indication indicating each IPsec operation mode supported by the IAB node. The supported IPsec operation mode may be: a tunnel mode, a transport mode, or both the tunnel mode and the transport mode.

The mapping configurator 525 in this example may configure a downlink mapping rule for a DU of the IAB donor. The downlink mapping rule indicates: a mapping relationship between IP header information and backhaul adaptation protocol (BAP) routing identities (IDs); and/or a mapping relationship between IP header information and backhaul radio link control (RLC) channels. The IP header information comprises information related to at least one of: IPsec address, differentiated services code point (DSCP), differentiated services (DS), or flow label.

In various embodiments, each IP address may comprise at least one of: an IPv6 prefix, an IPv6 address, or an IPv4 address; and each IPsec address may comprise at least one of: an IPv6 prefix, an IPv6 address, or an IPv4 address.

The various modules discussed above are coupled together by a bus system 530. The bus system 530 can include a data bus and, for example, a power bus, a control signal bus, and/or a status signal bus in addition to the data bus. It is understood that the modules of the IAB donor 500 can be operatively coupled to one another using any suitable techniques and mediums.

Although a number of separate modules or components are illustrated in FIG. 5, persons of ordinary skill in the art will understand that one or more of the modules can be combined or commonly implemented. For example, the processor 504 can implement not only the functionality described above with respect to the processor 504, but also implement the functionality described above with respect to the address information analyzer 520. Conversely, each of the modules illustrated in FIG. 5 can be implemented using a plurality of separate components or elements.

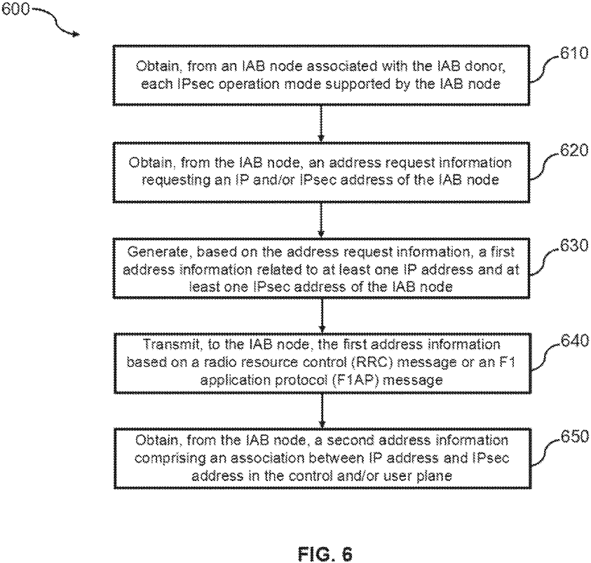

FIG. 6 illustrates a flow chart for a method performed by an IAB donor, e.g. the IAB donor CU 500 in FIG. 5, for address configuration, in accordance with some embodiments of the present disclosure. At operation 610, the IAB donor CU obtains, from an IAB node associated with the IAB donor CU, each IPsec operation mode supported by the IAB node. At operation 620, the IAB donor CU obtains, from the IAB node, an address request information requesting an IP and/or IPsec address of the IAB node. At operation 630, the IAB donor CU generates, based on the address request information, a first address information related to at least one IP address and at least one IPsec address of the IAB node. At operation 640, the IAB donor CU transmits, to the IAB node, the first address information based on a radio resource control (RRC) message or an F1 application protocol (F1AP) message. At operation 650, the IAB donor CU obtains, from the IAB node, a second address information comprising an association between IP address and IPsec address in the control and/or user plane. The orders of operations in FIG. 6 may be changed in various embodiments of the present disclosure.

Different embodiments of the present disclosure will now be described in detail hereinafter. It is noted that the features of the embodiments and examples in the present disclosure may be combined with each other in any manner without conflict.

In a first embodiment, an IAB node in an IAB network obtains its local IPsec address and IP address from an OAM associated with the IAB network. The IAB node may obtain at least one of the following from the OAM: IPsec address(es); IP address(es): IPsec address(es) for the control plane; IPsec address(es) for user plane; IPsec address(es) for the control plane, and the control plane IP address(es) associated with each IPsec address; IPsec address(es) for the user plane, and the user plane IP address(es) associated with each IPsec address.

If the OAM does not indicate the IPsec address or IP address used for the control or user plane, the IAB node can determine by itself the IPsec address or IP address used for the control or user plane. The IAB node sends to the donor CU control plane (donor CU-CP) via an RRC or F1AP message at least one of the following information: IPsec address(es); IP address(es); IPsec address(es) for the control plane; IPsec address(es) used for the control plane, and the control plane IP address(es) associated with each control plane IPsec address.

In a second embodiment, an IAB node in an IAB network obtains its local IPsec address from an OAM associated with the IAB network, and obtains its local IP address from the donor CU or donor DU associated with the IAB node. The IAB node sends an address request information to the donor CU through an RRC message, including a request for at least one of the following: IPsec address(es); control plane IPsec address(es); user plane IPsec address(es); a quantity of IP addresses associated with each IPsec address.

After the donor CU receives the address request information, the donor CU may perform actions according to different embodiments. In one embodiment, the donor CU may send the IP address, assigned by the donor CU or obtained from a donor DU, to the IAB node via an RRC message. The IAB node determines the control plane IP address associated with each control plane IPsec address, and the user plane IP address associated with each user plane IPsec address, and sends the association results to the donor CU-CP via an RRC or F1 message. In another embodiment, the donor CU or donor DU indicates the IPsec address and IP address for the control plane and/or user plane. The IAB node determines by itself the control plane IP address associated with each control plane IPsec address, and the user plane IP address associated with each user plane IPsec address, and sends the association results to the donor CU-CP via an RRC or F1 message. In yet another embodiment, the donor CU or donor DU determines and configures the control plane IP address associated with each control plane IPsec address, and the user plane IP address associated with each user plane IPsec address. The donor CU sends the configuration result to the IAB node through an RRC message. If the IP address is assigned by the donor DU, the donor CU can first obtain the configuration result from the donor DU through an F1AP message.

Optionally, the donor CU determines the IPsec address for the control plane and/or user plane. In one example, when requesting an IP address from the donor DU, the donor CU sends the IPsec address for the control plane and/or user plane to the donor DU through an F1AP message. The donor DU allocates an IP address for the IAB node and determines: the control plane IP address associated with a control plane IPsec address, and/or the user plane IP address associated with a user plane IPsec address. The donor DU sends the association results to the donor CU-CP through an F1 message. The donor CU then sends the association results to the IAB node through an RRC message.

In another example, after the donor CU obtains the IP address of the IAB node from the donor DU, the donor CU determines: the control plane IP address associated with a control plane IPsec address, and/or the user plane IP address associated with a user plane IPsec address. The association result is sent to the IAB node via an RRC message.

In yet another example, after the donor CU obtains the IP address of the IAB node from the donor DU. the donor CU transmits to the IAB node through an RRC message, information about: the IP address, which IPsec address is used for the control plane, and/or which IPsec address is used for the user plane. The IAB node determines by itself: the control plane IP address associated with each control plane IPsec address, and the user plane IP address associated with each user plane IPsec address, and sends the association results to the donor CU-CP via an RRC or F1AP message.

In a third embodiment, an IAB node in an IAB network obtains its local IPsec address and IP address from the donor CU associated with the IAB node. After receiving the address request message from the IAB node, the donor CU will send the assigned address to the IAB node through an RRC message. The RRC message contains information according to at least one of the following scenarios.

In a first scenario, the RRC message contains IPsec address and IP address of the IAB node. Under this scenario, the IAB node determines by itself the IPsec addresses and IP addresses for the control plane and user plane, as well as the control plane IP address associated with a control plane IPsec address and/or the user plane IP address associated with a user plane IPsec address, and then sends the association result to the donor CU through an RRC or F1AP message.

In a second scenario, the RRC message contains the IPsec address and IP address of the IAB node for the control plane and/or the user plane. The IAB node determines by itself the IPsec addresses and IP addresses for the control plane and user plane, as well as the control plane IP address associated with a control plane IPsec address and/or the user plane IP address associated with a user plane IPsec address, and then sends the association result to the donor CU through an RRC or F1AP message.

In a third scenario, the RRC message contains: the control plane IPsec address, and the control plane IP address associated with a control plane IPsec address, and/or the user plane IPsec address, and the user plane IP address associated with a user plane IPsec address.

In a fourth embodiment, the donor CU allocates an IPsec address of the IAB node, and the donor DU allocates an IP address of the IAB node. The IAB node sends an address request message to the donor CU through an RRC message. After receiving the address request message from the IAB node, the donor CU will feedback the address allocation result through an RRC message, including information according to at least one of the following scenarios.

In a first scenario, the RRC message includes the IPsec address and the IP address obtained from the donor DU. The IAB node determines the IPsec address and IP address for the control plane and user plane, and the control plane IP address associated with a control plane IPsec address, and/or the user plane IP address associated with a user plane IPsec address, and then sends the association result to the donor CU through an RRC or F1AP message.

In a second scenario, the donor CU determines the IPsec addresses used for the control and user planes, and then sends the IPsec addresses and the IP addresses obtained from the donor DU to the IAB node through an RRC message. The IAB node determines the control plane IP address associated with a control plane IPsec address and/or the user plane IP address associated with a user plane IPsec address, and then sends the association result to the donor CU through an RRC or F1AP message.

In a third scenario, the donor CU determines the IPsec addresses used for the control and user planes. After receiving the IP address sent by the donor DU, the donor CU determines the control plane IP address associated with a control plane IPsec address and/or the user plane IP address associated with a user plane IPsec address, and then sends the association result to the IAB node through an RRC message.

In a fourth scenario, the donor CU sends the assigned IPsec address to the donor DU. The donor DU determines the IPsec addresses used for the control plane and user plane, and the control plane IP address associated with a control plane IPsec address, and/or the user plane IP address associated with a user plane IPsec address, then sends the association result to the donor CU through an F1AP message. The donor CU sends the association result to the IAB node through an RRC message.

In a fifth embodiment, the donor DU allocates an IPsec address of the IAB node, and the donor CU allocates an IP address of the IAB node. After the donor CU receives an address request message from the IAB node, the donor CU may perform actions according to one of the following scenarios.

In a first scenario, the donor CU sends the address request related information or the IPsec address request information to the donor DU through an F1AP message. The donor DU feeds back the allocated IPsec address. The donor CU sends the assigned IP address and the IPsec address obtained from the donor DU to the IAB node via an RRC message. The IAB node determines the IPsec address and IP address for the control plane and user plane, and the control plane IP address associated with a control plane IPsec address and/or the user plane IP address associated with a user plane IPsec address, and then sends the association result to the donor CU through an RRC or F1AP message.

In a second scenario, the donor CU sends the address request related information or the IPsec address request information to the donor DU through an F1AP message. The donor DU feeds back the allocated IPsec address, or indicates the IPsec addresses for the control plane and user plane. The donor CU determines the IP address for the control plane and/or the user plane. Further, if the donor DU does not distinguish between the control plane and the user plane IPsec addresses, the donor CU determines the IPsec address for the control plane and/or the user plane. The donor CU sends the IPsec address and IP address for the control plane and/or user plane to the IAB node through an RRC message. The IAB node determines the control plane IP address associated with a control plane IPsec address and/or the user plane IP address associated with a user plane IPsec address, and then sends the association result to the donor CU through an RRC or F1AP message.

In a third scenario, the donor CU sends the address request related information or the IPsec address request information to the donor DU through an F1AP message. The donor DU feeds back the allocated IPsec addresses, or feeds back the IPsec addresses for the control plane and user plane. The donor CU determines the IP addresses for the control plane and user plane. Further, if the donor DU does not distinguish between the control plane and the user plane IPsec addresses, the donor CU determines the IPsec address for the control plane and/or the user plane. The donor CU determines the control plane IP address associated with a control plane IPsec address and/or the user plane IP address associated with a user plane IPsec address, and then sends the association result to the IAB node through an RRC message.

In a fourth scenario, the donor CU sends the address request related information or the IPsec address request information to the donor DU through an F1AP message. The F1AP message also includes the IP address allocated by the donor CU, or the IP address set for the control plane and/or the user plane. The donor DU determines the control plane IP address associated with a control plane IPsec address and/or the user plane IP address associated with a user plane IPsec address, and then sends the configuration result to the donor CU through an F1AP message. The donor CU sends the configuration result to the IAB node through an RRC message.

In a sixth embodiment, the donor DU allocates or assigns the IPsec address and IP address for the IAB node. After the donor CU receives an address request information from the IAB node, the donor CU may forward the address request information to the donor DU through an F1 interface. The donor DU then feeds back an F1AP message to the donor CU. The F1AP message may include information according to one of the following scenarios.

In a first scenario, the F1AP message includes IPsec address and IP address. Under this scenario, after the donor CU receives the feedback message, the donor CU may perform actions according to one of the following cases.

In a first case, the donor CU sends the IPsec address and the IP address to the IAB node through an RRC message. The IAB node determines the IPsec address and IP address for the control plane and user plane, and the control plane IP address associated with a control plane IPsec address and/or the user plane IP address associated with a user plane IPsec address, and then sends the association result to the donor CU through an RRC or F1AP message.

In a second case, the donor CU determines the IPsec address and IP address for the control plane and the user plane, and sends the assigned address to the IAB node through an RRC message. The IAB node determines the control plane IP address associated with a control plane IPsec address and/or the user plane IP address associated with a user plane IPsec address, and then sends the association result to the donor CU via an RRC or F1AP message.

In a third case, the donor CU determines the IPsec address and IP address for the control plane and user plane, and the control plane IP address associated with a control plane IPsec address and/or the user plane IP address associated with a user plane IPsec address, and then sends the association result to the IAB node through an RRC message.

In a second scenario, the F1AP message includes IPsec addresses and IP addresses for the control plane and/or for the user plane. Under this scenario, after the donor CU receives the feedback message, the donor CU may perform actions according to one of the following cases.

In a first case, the donor CU sends the address allocation result to the IAB node through an RRC message. The IAB node determines the control plane IP address associated with a control plane IPsec address and/or the user plane IP address associated with a user plane IPsec address, and then sends the association result to the donor CU via an RRC or F1AP message.

In a second case, the donor CU determines the control plane IP address associated with a control plane IPsec address and/or the user plane IP address associated with a user plane IPsec address, and then sends the association result to the IAB node through an RRC message.

In a seventh embodiment, when the downlink (DL) IP packet sent by the donor CU to the donor DU is encrypted by IPsec tunnel, the donor DU may only see the IPsec address. In this case, the donor CU may configure a DL mapping rule for the donor DU. The DL mapping rule contains at least one of: a mapping relationship between IP header information and backhaul adaptation protocol (BAP) routing identities (IDs); and a mapping relationship between IP header information and backhaul radio link control (RLC) channels. The IP header information comprises information related to at least one of: IPsec address, differentiated services code point (DSCP), differentiated services (DS), or flow label.

In any of the embodiments disclosed herein, the donor CU control plane (donor CU-CP) may send, via an E1 application protocol (E1AP) to the donor CU user plane (donor CU-UP), at least one user plane IPsec address and at least one user plane IP address associated with each user plane IPsec address.

In an eight embodiment, for the IPsec address of the donor CU-CP, the IAB node can obtain it through the OAM. Alternatively, the donor CU-CP can send, to the IAB node through an RRC message, information related to the IPsec address of the donor CU-CP. The RRC message may include at least one of: the donor CU-CP IPsec address(es); or the donor CU-CP IPsec address(es), and the control plane IP address(es) associated with each IPsec address.

In any of the embodiments disclosed herein, each of the IP address and IPSec address includes: IPv6 prefix, IPv6 address, and/or IPv4 address.

In any of the embodiments disclosed herein, the IAB node may report to the donor CU the IPsec operation mode(s) supported by the IAB node, through capability reporting. For example, the IAB node may support: a tunnel mode, a transport mode, or both the tunnel mode and the transport mode.

In any of the embodiments disclosed herein, the IAB node may send the address request information to the donor CU through an RRC message, which includes at least one of the following: a request for an IPsec address; a number of requested IPsec addresses; a request for control plane IPsec address: a request for user plane IPsec address; a number of requested control plane IPsec addresses; a number of requested user plane IPsec addresses; the requested IPsec address version, e.g. IPv4 or IPv6; an indication indicating the number of IP addresses associated with each IPsec address; an indication indicating the number of control plane IP addresses associated with each control plane IPsec address; or an indication indicating the number of user plane IP addresses associated with each user plane IPsec address.

In any of the embodiments disclosed herein, the donor CU may send the address request information or IPsec address request information to the donor DU through an F1AP message, which includes at least one of the following: a request for an IPsec address; a number of requested IPsec addresses: a request for control plane IPsec address; a request for user plane IPsec address; a number of requested control plane IPsec addresses: a number of requested user plane IPsec addresses; the requested IPsec address version, e.g. IPv4 or IPv6; an indication indicating the number of IP addresses associated with each IPsec address; an indication indicating the number of control plane IP addresses associated with each control plane IPsec address; an indication indicating the number of user plane IP addresses associated with each user plane IPsec address: a request for an IP address; a request for control plane IP address; or a request for user plane IP address.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module”), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules: however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1-44. (canceled)

45. A method performed by a first network node, the method comprising:
obtaining, from an operations administration and maintenance (OAM) or a second network node, a first address information related to at least one Internet Protocol security (IPsec) address;
generating, based on the first address information, a second address information; and
transmitting, to the second network node, the second address information based on a radio resource control (RRC) message, wherein the first network node and the second network node are connected via a backhaul link in an integrated access and backhaul (IAB) network.

46. The method of claim 45, wherein:
the first address information is obtained from the OAM and is related to at least one Internet Protocol (IP) address and at least one IPsec address of the first network node;
the first network node is an IAB node;
the second network node is a central unit (CU) of an IAB donor associated with the IAB node; and
the second address information comprises information related to at least one of the following:
at least one IPsec address of the first network node,
at least one IP address of the first network node,
at least one IPsec address used for a control plane, or
at least one IPsec address used for the control plane, and at least one IP address used for the control plane and associated with each IPsec address used for the control plane.

47. The method of claim 45, wherein:
the first address information is obtained from the OAM and is related to at least one IPsec address of the first network node;
the first network node is an IAB node; and
the second network node is a central unit (CU) of an IAB donor associated with the IAB node.

48. The method of claim 47, wherein the second address information comprises information related to at least one of the following:
at least one IPsec address of the first network node,
at least one IPsec address used for a control plane,
at least one IPsec address used for a user plane, or
a quantity of at least one IP address associated with each IPsec address used for the control plane or the user plane.

49. The method of claim 45, further comprising:
transmitting, to the second network node, an address request information based on a radio resource control (RRC) message, wherein:
the first address information is obtained from the second network node in response to the address request information,
the first address information is related to at least one IP address and at least one IPsec address of the first network node, and
each of the at least one IP address and the at least one IPsec address is assigned by the second network node or a third network node of the IAB network based on the address request information.

50. The method of claim 45, wherein:
the first address information is related to at least one IPsec address of the second network node;
the first network node is an IAB node;
the second network node is a central unit (CU) of an IAB donor associated with the IAB node; and
the first address information comprises information related to at least one of the following:
at least one IPsec address of the second network node,
at least one control plane IPsec address of the second network node, or
at least one control plane IP address associated with each control plane IPsec address of the second network node.

51. The method of claim 50, further comprising:
transmitting, to the second network node, an indication indicating each IPsec operation mode supported by the first network node, wherein the first network node supports one of:
a tunnel mode,
a transport mode, or
both the tunnel mode and the transport mode.

52. The method of claim 45, wherein:
the first network node is an IAB node;
the second network node is a central unit (CU) of an IAB donor associated with the IAB node; and
a control plane of the CU of the IAB donor sends, via an E1 application protocol (E1AP) interface to a user plane of the CU of the IAB donor, at least one IPsec address used for the user plane, and at least one IP address used for the user plane and associated with each IPsec address used for the user plane.

53. A method performed by a first network node, the method comprising:
transmitting, to a second network node, an address request information based on an F1 application protocol (F1 AP) message; and
obtaining, from the second network node, a first address information related to at least one IP address or at least one IPsec address of a third network node in response to the address request information, wherein
the first network node and the second network node are connected via an F1 interface in an integrated access and backhaul (IAB) network, and
the first network node and the third network node are connected via a backhaul link in the IAB network.

54. The method of claim 53, wherein:
the first network node is a central unit (CU) of an IAB donor;
the second network node is a distributed unit (DU) of the IAB donor;
the third network node is an IAB node associated with the IAB donor;
the first address information is related to at least one IP address of the IAB node;
the method further comprises transmitting, to the IAB node, a second address information based on a radio resource control (RRC) message; and
the second address information comprises information related to at least one of the following:
at least one IPsec address of the IAB node,
at least one IPsec address of the IAB node used for a control plane,
at least one IPsec address of the IAB node used for a user plane,
at least one IP address of the IAB node,
at least one IP address used for the control plane,
at least one IP address used for the user plane, or
at least one IP address associated with each IPsec address used for the control plane or the user plane.

55. The method of claim 53, further comprising configuring, for the second network node, a downlink mapping rule, which indicates at least one of:
a mapping relationship between IP header information and backhaul adaptation protocol (BAP) routing identities (IDs); and
a mapping relationship between IP header information and backhaul radio link control (RLC) channels, wherein the IP header information comprises information related to at least one of: IPsec address, differentiated services code point (DSCP), differentiated services (DS), or flow label.

56. The method of claim 53, wherein:
the first network node is a central unit (CU) of an IAB donor;
the second network node is a distributed unit (DU) of the IAB donor; and
a control plane of the CU of the IAB donor sends, via an E1AP interface to a user plane of the CU of the IAB donor, at least one IPsec address used for the user plane, and at least one IP address used for the user plane and associated with each IPsec address used for the user plane.

57. A method performed by a first network node, the method comprising:
transmitting, to a second network node, a first address information related to at least one Internet Protocol security (IPsec) address; and
obtaining, from the second network node based on a radio resource control (RRC) message, a second address information generated based on the first address information, wherein the first network node and the second network node are connected via a backhaul link in an integrated access and backhaul (IAB) network.

58. The method of claim 57, wherein:
the first address information is related to at least one IPsec address of the first network node;
the second network node is an IAB node; and
the first network node is a central unit (CU) of an IAB donor associated with the IAB node.

59. The method of claim 58, wherein the second address information comprises information related to at least one of the following:
at least one IPsec address of the second network node,
at least one IPsec address used for a control plane,
at least one IPsec address used for a user plane, or
a quantity of at least one IP address associated with each IPsec address used for the control plane or the user plane.

60. The method of claim 57, further comprising:
obtaining, from the second network node, an address request information based on a radio resource control (RRC) message, wherein:
the first address information is transmitted to the second network node in response to the address request information,
the first address information is related to at least one IP address and at least one IPsec address of the second network node, and
each of the at least one IP address and the at least one IPsec address is assigned by the first network node or a third network node of the IAB network based on the address request information.

61. The method of claim 60, wherein:
the second network node is an IAB node;
the first network node is a central unit (CU) of an IAB donor associated with the IAB node;
the third network node is a distributed unit (DU) of the IAB donor associated with the IAB node; and
the address request information comprises information related to at least one of the following:
a request for at least one IPsec address,
a request for a number of at least one IPsec address,
a request for at least one IPsec address used for a control plane,
a request for at least one IPsec address used for a user plane,
a request for a number of at least one IPsec address used for a control plane,
a request for a number of at least one IPsec address used for a user plane,
a request for an IPsec address version,
an indication of a number of at least one IP address associated with each IPsec address,
an indication of a number of at least one control plane IP address associated with each control plane IPsec address, or
an indication of a number of at least one user plane IP address associated with each user plane IPsec address.

62. The method of claim 61, wherein:
the first address information is related to at least one IPsec address of the first network node;
the second network node is an IAB node;
the first network node is a central unit (CU) of an IAB donor associated with the IAB node; and
the first address information comprises information related to at least one of the following:
at least one IPsec address of the first network node,
at least one control plane IPsec address of the first network node, or
at least one control plane IP address associated with each control plane IPsec address of the first network node.

63. The method of claim 62, further comprising:
obtaining, from the second network node, an indication indicating each IPsec operation mode supported by the second network node, wherein the second network node supports one of:
a tunnel mode,
a transport mode, or
both the tunnel mode and the transport mode.

64. The method of claim 57, wherein:
the second network node is an IAB node;
the first network node is a central unit (CU) of an IAB donor associated with the IAB node; and
a control plane of the CU of the IAB donor sends, via an E1AP interface to a user plane of the CU of the IAB donor, at least one IPsec address used for the user plane, and at least one IP address used for the user plane and associated with each IPsec address used for the user plane.
